(19) United States
(12) Patent Application Publication
(10) Pub. No.: US 2009/0100099 A1
(43) Pub. Date: Apr. 16, 2009

(54) METHOD AND APPARATUS FOR PROVIDING AND OFFERING AN EXCHANGE DATABASE

(76) Inventor: Alan M. Buckwalter, Glen Rock, NJ (US)

Correspondence Address: BUCKLEY, MASCHOFF & TALWALKAR LLC, 50 LOCUST AVENUE, NEW CANAAN, CT, 06840, US

(21) Appl. No.: 12/189,032

(22) Filed: Aug. 8, 2008

Related U.S. Application Data
(60) Provisional application No. 60/954,680, filed on Aug. 8, 2007.

(51) Int. Cl. G06F 17/30

(52) U.S. Cl. 707/104.1; 707/E17.009

(57) ABSTRACT

A system and method for providing an exchange database system is provided in some embodiments, the method includes automatically collecting contact information associated with a business or service provider; storing the automatically collected contact information in a plurality of data records, each data record being associated with a business or service provider; inviting the business or service provider associated with each of the plurality of data records to verify the automatically collected contact information and to subscribe to a service to maintain their associated contact information; and providing access the automatically collected contact information to subscribers and non-subscribers.

### FIELD OF THE INVENTION

Some embodiments herein relate to communications systems. More particularly, some embodiments relate to systems, methods and apparatus for providing and offering an exchange database.

### BACKGROUND

Many segments of society are becoming increasingly dependent on various forms of electronic communication, both for formal and informal correspondence. Quite often it is easier and more convenient, for either or both the sender and recipient to use e-mail or other electronic systems as a primary means of communication. Both the sender and the recipient of the correspondence may send and respond to questions and other messages at a convenient time when normal voice communication might not be possible, desirable or practical. People increasingly want and expect to be able to contact others, for both business and personal reasons, when they want to and when they need to without undesirable delays. In addition to having access to various electronic means of communication, people also need to know the contact information of the business and person(s) they wish to communicate with. For example, consumers increasingly want and need more direct access to the business companies they deal with, including being able to reach the appropriate personnel at those business entities.

Despite the need and desire to be able to reach others in a timely and convenient manner, including knowing the proper entity and their corresponding contact information, a number of directory services only provide an address and/or telephone contact information for the listings in the directory. Such listings do not provide, for example, the contextual information that may be necessary for individuals to contact the most appropriate person or department within an organization. In some instance, these generic directory listings merely serve as a staring point in the communication process. The individual looking to contact another person or business may start with the listing provided in these conventional directories but oftentimes needs additional information in order to determine that they have the listing for the person or business entity they wish to contact, including complete and accurate contact information.

Accordingly, there exists a need for a method and system to provide direct and targeted communication with businesses and individuals, with the speed and tracking of electronic communication.

The present disclosure may be more clearly understood by reference to the following detailed description of the invention, the appended claims, and the drawings attached hereto.

### DESCRIPTION OF THE DRAWINGS

The accompanying drawings, which are incorporated herein and form a part of the specification, illustrate some embodiments of the present disclosure, and together with the descriptions serve to explain the principles thereof.

FIG. 1 is an exemplary block diagram illustrating a system environment suitable and supportive of some embodiments herein;

FIG. 2 is an illustrative depiction of an apparatus, in accordance with some embodiments herein;

FIG. 3 is an exemplary illustration of a number of databases of FIG. 2;

FIGS. 4-22 provide illustrative depictions of various interfaces in accordance with embodiments herein; and

FIG. 23 is an exemplary flow diagram of an overall process, in accordance with some embodiments herein.

### DETAILED DESCRIPTION

Features of some embodiments are described in the following pages. Those skilled in the art will appreciate that a number of aspects may be implemented using different technologies or techniques, and that the following details are provided for illustration. The data presented is merely for the purposes of illustration. A number of different table structures, field names, and data may be utilized pursuant to the present invention.

Pursuant to some embodiments, users (e.g., businesses, individuals, families, and other groupings), including subscribers, are able to create, and maintain one or more electronic records identifying an individual or business contact, where the electronic record includes an associated email address(es) and other optional data associated with the individual or business contact. In some embodiments, internet users may search the exchange database via a web site, to obtain information regarding an individual, family or business contact. In some instances, searching via a web site may be facilitated by one or more browser toolbars, applications, desktop widgets, applications, services, and interfaces. In some embodiments, the users are not required to pay a fee to obtain the sought after contact information.

Pursuant to some embodiments, a system is provided (referred to herein as an “email exchange” or “Email Exchange”) that provides and supports a global, online email directory & database of business and personal electronic contact information including, for example, an email, a web page, a telephone number (e.g., landline, voice over internet phone (voip), mobile, etc.), and other contact information associated with a directory listing. The email exchange herein provides a mechanism to share and advertise business and personal contact information in an efficient, on demand, alternative means of communication. Some embodiments allow users a capability to determine or otherwise obtain the contact information for a business or individual in an efficient manner to address a request for such information in a number of different situations, such as but not limited to the following examples:
What is the email address of the technical support center at my cable company?
How can I email customer service at a business (e.g., Sears®)?
I want to email a question and an attachment to XYZ investor services, what is their email address?
What is the email address of my friend John Smith, who lives in Orlando, Fla.?
What is the email address of the Jones family, living next door?
Who is alan@CompanyABC.net who keeps sending me mail? (reverse lookup scenario)
Who can I email in the auto parts industry in my town?
How do I clean the lint filter for my Sears® model # 1357 gas dryer, given the facts it is 9:45 pm in the evening, customer service is closed, I cannot locate the desired information on the company's web page, I will not be able to call the company the next day, and I am looking for an appropriate email address for Sears® house wares, washers and dryers?

Applicant has recognized that a system (referred to herein as “The Email Exchange” or the “exchange database”) is needed to provide a global, online email directory of business and personal electronic contact information (email, text/IM addresses, web pages, etc.). Pursuant to some embodiments, the system may replace menu driven telephone automated call directors and dramatically improve on the concept of generic email addresses (e.g. help@company.com). The system may save consumers hours otherwise needed to surf company web sites or sifting through inexact search engine results, whether general search engines or focused search engines. The exchange data provides an efficient, one stop user/consumer to business service, allowing data sharing and advertising in an efficient, on demand, means of communication. The exchange database system herein may provide a one-stop directory of business and individual contact information for all forms and means of electronic communication.

In some embodiments, subscribers to a system and service herein may be businesses, individuals, families, and other associated groupings of individuals. The subscribers may be able to create and maintain one or more electronic (e.g., digital) records identifying contacts, the associated electronic address(es) and other optional data.

In some embodiments, data included or associated with a contact record may include, be sorted, and be indexed by company, keywords, subject matter, geographic location, etc. The exchange database may be accessible from a web browser, toolbar, using a desktop widget/gadget, Smartphone/PDA or other mobile device.

Applicant has recognized that the use of traditional search engines suffers from a number of disadvantages when presenting and collecting information. For example, conventional search engines typically start with generic phrases that require the user to refine their query iteratively to narrow the results before, if ever, returning the desired match.

Embodiments of the present disclosure however may start with a narrow search focus, locate the target more quickly and more accurately than heretofore directories. For example, most conventional telephone directories do not offer (any or all of) the electronic contact information discussed here. This makes embodiments of the present invention highly attractive to consumers as well as businesses that can more accurately direct consumers within their organizations earlier in the communication process.

Maintenance of the system of the present invention and the data records therein (e.g., the subject, department, location, keywords, granularity and accuracy) may preferably be the responsibility of the subscriber of the system and service herein. Additionally, the data records may be made available to the subscriber in real-time. In this manner, the present system provides the subscriber with immediate and direct access to the content presented online, along side with the contact content of others (e.g., their competitors).

In accordance herewith, subscribers and other users of the present system and method may greatly benefit from having a single place to research and reach out to businesses, rather than having to spend undue time searching the Internet, individual business sites, and paper directories.

Applicant has recognized that embodiments of the present disclosure may provide a number of benefits to different participants. Some of the participants may include business subscribers, individuals, and families.

Regarding businesses, some embodiments may provide highly efficient advertising and improved customer service relations. Business subscribers may benefit from the efficiencies of the present disclosure by forming or at least enhancing an electronic relationship with their customers. Email communication is fast, efficient, may be archived, analyzed/mined to yield a wealth of extremely valuable data to better understand needs, demands, trends, problems and concerns for a variety of purposes beyond just marketing and advertising. While some corporations may have a web site and public email addresses, there is no simple and efficient way to get this information out to the general public. As a result, countless people spend hours searching general purpose search engines or a corporate web site looking for a way to send an email (or other communication) to sales, customer service, technical support, investor relations, etc.

A “one stop shopping” consolidated service such as that disclosed herein may be cost effective for small businesses trying to maximize their advertising dollars, while still being effective to reach large numbers of the mass public. The present systems and methods may provide a great value to consumers, saving them the time, money, and frustration over searching for the same information themselves from disparate sources.

In some instances, large, small businesses, and startups alike may outsource the function and maintaining their company directory contact information associated with systems and methods herein. In some aspects, an API, database restrictions, and other security functionality may be utilized to provide and support tiered access to subsets of the data using, in some instances, the same or similar infrastructure.

Regarding individuals and families, some embodiments provide a mechanism for access to provide and maintain associated contact information. In addition to all the benefits described above in connection with a business, embodiments herein may be used by individuals and families (or other groupings of individuals) to increase electronic communication traffic and usage of electronic means of communication.

In some embodiments, some of the benefits realized by the present disclosure relate to all users/subscribers. Some embodiments may include, offer, or support the following features or options:
custom or personal email distribution lists and directories;
email change notification when an email address (or other information) associated with a contact entry listing in an individual entity's personal list changes;
the collection of business or industry specific data and making the same available to a company in electronic form so that companies may, for example, review, analyze, and process this type of information for marketing, resource allocation, process and product improvement, cost control, and other reasons;
the collection of generic industry or market segment data and making the same invaluable to facilitate companies in evaluating their market size, share, growth opportunities, recurring questions, problems, etc.;
an opportunity for outsourcing and off-shoring contact information services, thereby reducing a number of barriers encountered with supporting and maintaining voice communication and location;
an opportunity to reduce resources allocated to the management and maintenance of a company's contact directory since the exchange database herein may support all of the features needed to host a company directory, including, for example, online and bulk updates, permissions and restricted access, departmental grouping, etc.; and
an all-inclusive depository of contact information so that individuals and businesses may maintain and update their contact information in the event of changes such as, for example, a change of internet service provider, email provider (personal and/or business-related), and other contact information.

Pursuant to some embodiments, an initial or periodic collection of information for the exchange database herein may use or include web crawling applications capable of collecting email addresses and other contact associated information and algorithmically categorizing records. In some embodiments, information gathered via the initial or periodic collection of data, either automatically or manually invoked, may be identified with an “un-verified” notation and an expiration date until the collected contact information is verified as accurate. In the event the information is not verified prior to the expiration date, then the “un-verified” information may be deleted.

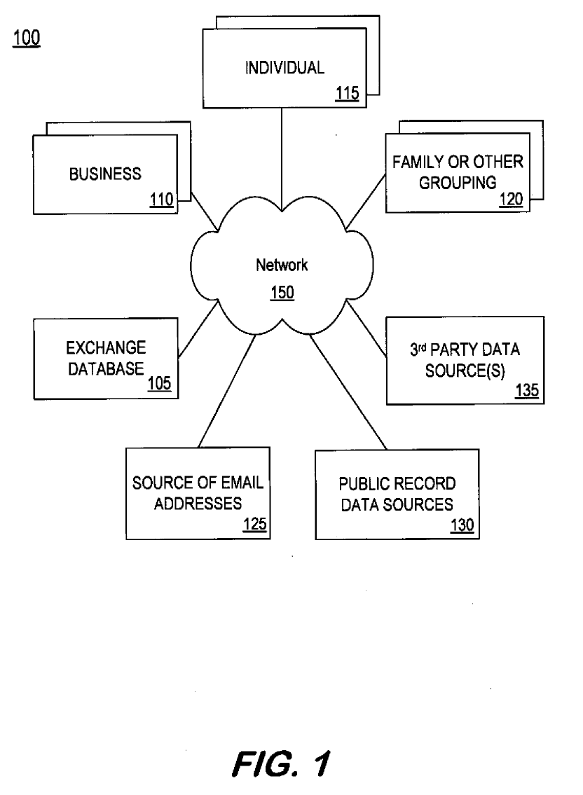

Referring to FIG. 1, an exemplary system 100 depicting a context or environment suitable for some embodiments herein is illustrated. System 100 includes an exchange database or Email Exchange device, system, application, service 105. Exchange database 105 may be in communication or interfaced with one or more other entities via a network 150. Exchange database 105 may be in communication or interfaced with a number of data sources capable of or associated with a variety of users and subscribers, including business(es) 110, individual(s) 115, and family or other groupings 120. The data sources may include, but are not necessarily limited to, a source of email addresses 125, a public records data source 130, and various 3^{rd} party data sources 135 that may have, maintain, or at least provide access to contact information that may be used by exchange database 105, in accordance with methods disclosed herein.

In some embodiments, exchange database 105 may be varied or adapted to meet the particular needs of a exchange database implementation or process for establishing, maintaining, and updating of exchange database 105. The responsibilities and functionality of exchange database 105 may be varied to include all or only certain aspects of establishing, maintaining, and updating of exchange database 105. The scope of responsibility or functionality assigned to any exchange database 105 may be based, at least in part, on a type of user and the particular type of contact information to be collected, indexed, stored, processed, queried, presented, etc.

Exchange database 105 may communicate directly or indirectly with users or subscriber 110, 115, 120, and the contact data sources 125, 130, 135. It should be appreciated that a communication link between the various entities of FIG. 1 may be established on an as-needed or ad-hoc basis. The illustrated connections therebetween in FIG. 1 are not intended to indicate a required or constant connection.

Exchange database 105 may include, use or comprise a single device or computer, a networked set or group of devices or computers, a workstation, etc. In some embodiments, exchange database 105 may implement or host a Web site, database, or other electronically accessible resource for purposes of implementing some embodiments described herein and for providing verification of contact information, including support for the querying of contact listings maintained by exchange database 105.

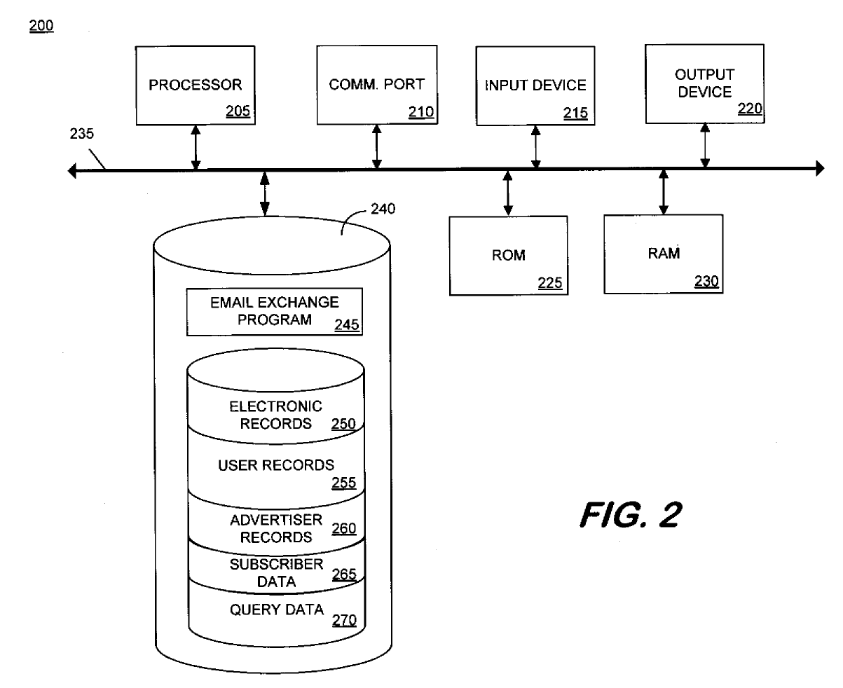

Referring to FIG. 2, a representative block diagram of a device that may be used by exchange database 105 is illustrated, generally represented by reference number 200. Device 200 may include a processor, a microchip, a central processing unit, or a microprocessor 205 that is in communication with or otherwise uses or includes one or more communication ports 210 for communicating with other devices. Communication ports 210 may include, for example, local area network adapters, wireless communication devices, Bluetooth® technology, etc. to provide an interface to, for example, network 150. In some embodiments, device 200 may include a PC, a mobile computing device, a smartphone, a mobile equipped with an internet browser or other suitable interface, and any number and variety of other computing devices suitable and/or adaptable for interfacing with the exchange database 105 disclosed herein.

In some embodiments, device 200 may include one or more input devices 215 (e.g., computer keyboard, computer mouse, roller ball, touch pad, joystick, touch screen, microphone, a bar code reader or other optical scanner, infrared or other receiver, antenna, magnetic stripe reader, image scanner, etc.), as well as one or more output devices 220 (e.g., a printer, infrared or other transmitter, antenna, audio speaker, display screen or monitor, text to speech converter, etc.). Device 200 may include Random Read-Only Memory (ROM) 225 and Random Access Memory (RAM) 230.

In some embodiments, device 200 acts as a server or at least includes functionality of a server for facilitating an roller ball, touch pad, joystick, touch screen, microphone, in accordance with various aspects of the disclosure herein. Device 200 may include a memory or data storage device 240 to store information, software, databases, communications, device drivers, reports, inquiries, service requests, etc. Memory or data storage device 240 preferably comprises an appropriate combination of magnetic, optical and/or semiconductor memory, and may include, for example, ROM, RAM, a tape drive, flash memory, a floppy disk drive, a compact disc and/or a hard disk, etc.

Processor 205 and data storage device 240 may each be, for example, located entirely within a single computer or other computing device, or connected to each other by a remote communication medium, such as a serial port cable, telephone line, or radio frequency transceiver. In some embodiments, device 200 may include or comprise one or more computers that are connected to a remote server computer for maintaining databases or may maintain and control databases such as, for example, a electronics records database 250, a users records database 255, an advertiser records database 260, a subscriber database 265, and a query data database 270.

In some embodiments, a conventional personal computer or workstation with sufficient memory and processing capability may be used as device 200. In some embodiments, device s00 may provide, host, operate, or implement an electronically accessible resource. For example, device 200 may operate as or include a Web site or database server for an Internet environment. The Web site or database may be accessible to client customers of the owner/operator entity of device 200.

In some embodiments, device 200 is capable of high volume transaction processing, performing a significant number of mathematical calculations in processing communications and database searches. In some embodiments, processor 205 may comprise one or more microprocessors, computers, computer systems, co-processors, etc.

Software may be resident and operating or operational on device 200. The software may be stored on the data storage device 240 and may include a email exchange program 145 for operating device 200, databases, etc. Email exchange program 145 may control processor 205. Processor 205 preferably performs instructions of email exchange program 245, and thereby to operate in accordance with the present disclosure, and particularly in accordance with the methods described herein. Email exchange program 245 may be stored in a compressed, uncompiled and/or encrypted format. Email exchange program 245 may include program elements that may be needed, such as an operating system, a database management system, and device drivers, for allowing processor 205 to interface with peripheral devices, databases, etc. Appropriate program elements are known to those skilled in the art, and need not be described in detail herein.

According to some embodiments of the present disclosure, instructions of email exchange program 245 may be read into a main memory from another computer-readable medium, such as from ROM 225 to RAM 230. Execution of sequences of the instructions in the control program causes processor 205 to perform the process steps described herein. In some embodiments, hard-wired circuitry may be used in place of, or in combination with, software instructions for implementation of some or all of the methods of the present disclosure. Thus, the various embodiments herein are not limited to any specific combination of hardware and software.

Processor 205, communication port 210, input device 215, output device 220, ROM 225, RAM 230, clock 235, and data storage device 240 may communicate or be connected, directly or indirectly, in a variety of ways. For example, processor 205, communication port 210, input device 215, output device 220, ROM 225, RAM 230, clock 235, and data storage device 240 may be connected via a bus 235.

While specific implementations and hardware configurations for device 200 have been illustrated, it should be noted that other implementations and hardware configurations are possible and that no specific implementation or hardware configuration is required. Thus, not all of the components illustrated in FIG. 2 may be needed for or included in a device implementing the methods disclosed herein. Therefore, many different types of implementations or hardware configurations can be used in system 200 and the methods disclosed herein are not limited to any specific hardware configuration.

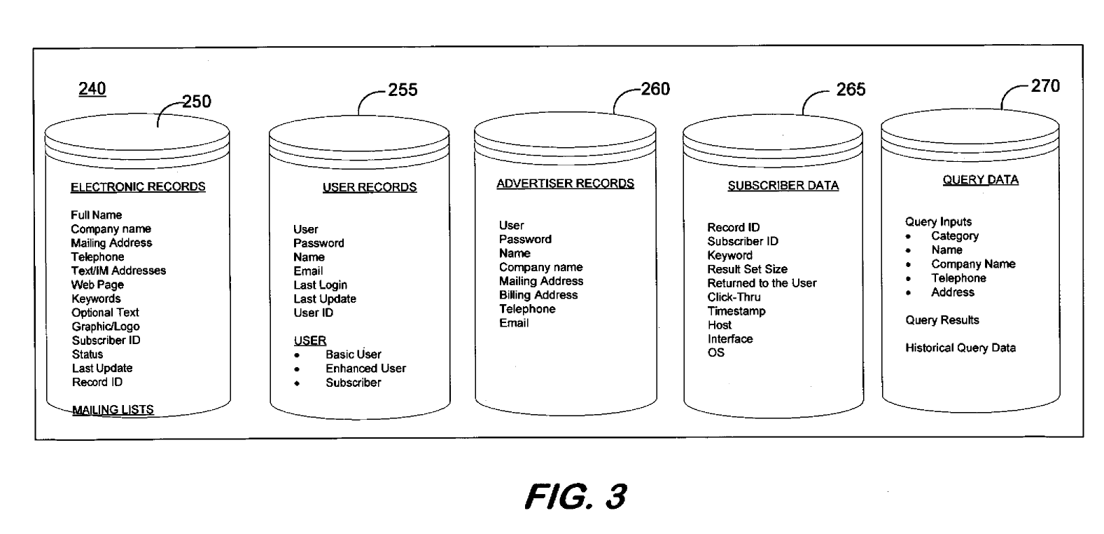

A number of databases 250, 255, 260, 265, and 270 are depicted in FIG. 3 (and further described herein). As mentioned above, in some embodiments herein an exchange database or Email Exchange program or other device or entity may access a storage device (e.g., storage device 240) that may include one or more databases for storing or keeping information regarding mailing lists, email addresses, contact information for a business or individual, and other data related to a directory listing.

Applicant notes that although a number of fields may be identified as being ‘required’ at various points throughout the present disclosure, those skilled in the art will recognize that other combinations and definitions of required fields may be provided. In the following description, each field described as a “required” field is verified and validated (using, for example, an automated process) prior to being committed to the Email Exchange database. Pursuant to some embodiments, all data may be subjected to screening and parsing for language, content and suitability. This screening and parsing process may be performed at the time of data entry or updates, as well as during periodic (manual and automated) scans of the service. Any data that fails to pass the screening and parsing processes or tests may be deleted or otherwise not included in an electronic contact record or listing, with a notification of such non-inclusion being sent back to the provider of the data.

Pursuant to some embodiments, access to System Fields of the present exchanged database may be restricted such that it may not be modified or viewed by end-users of any type. Instead, such fields may be viewable or accessed by authorized ‘administrative’ personnel.

For the purpose of illustrating various features of some embodiments, the following definitions are used. Again, those skilled in the art will appreciate that these definitions are illustrative and not exhaustive.

Definitions

| Term | Definition |
|---|---|
| Advertiser | A supplier of content that is presented to end-users of The Email Exchange |
| | service, through any one of the Interfaces in exchange for a payment |
| Advertiser API | A programmatic interface used by advertisers of The Email Exchange for |
| | adding, updating and removing content that they supply. |
| Data Content Tools | A collection of embedded and standalone tools used by The Email Exchange |
| | to validate/verify data content (for ALL record types) at the point of entry or |
| | update, and facilitate regular scans and audits of the system. |
| Delivery Channel | A mechanism through which a User of The Email Exchange can query the |
| | service and view the results. |
| Electronic Record | A collection of data that represents a single, not necessarily unique |
| | electronic destination. |
| End-user | A User, Enhanced User, Subscriber, Advertiser, or consumer of any data |
| | offered by The Email Exchange. |
| Enhanced User | A User of the service who may also create and maintain one or more Mailing |
| | Lists. |
| Generic Data | Usage data of The Email Exchange service that cannot be linked back to the |
| | subscriber who supplied it. |
| Interface | A mechanism through which any functionality of The Email Exchange can be |
| | accessed. |
| Mailing List | A named list of one or more contacts. |
| Security Process | A collection of embedded processes and standalone tools used by The |
| and Tools | Email Exchange to maintain and enforce system security and integrity for |
| | ALL functionality, services and data. |
| Subscriber | A supplier of electronic records which are captured and stored by The Email |
| | Exchange. |
| Subscriber API | A programmatic interface used by subscribers of The Email Exchange for |
| | adding, updating and deleting electronic records that they supply. |
| Subscriber Data | Usage data of The Email Exchange service that can be linked back to the |
| | specific Subscriber who supplied it. |
| Support Tools | A collection of utilities used by the employee (Support, Security, Billing, |
| | Technical, Management, etc) of The Email Exchange to perform a repetitive |
| | task required to analyze, maintain and support the service. |
| User | A consumer of electronic records captured and stored by The Email |
| | Exchange, accessed through one of the Interfaces. |

Delivery Channels and Interfaces

Pursuant to some embodiments and as introduced above, a Delivery Channel is a mechanism through which a User of The Email Exchange can query the service and view the results. A list of some Delivery Channels available from the Email Exchange herein includes:
a web browser;
an browser toolbar (plug-in);
a desktop widget, gadget, or other light-weight standalone desktop application;
a smartphone; and
a network ready PDA, Pocket PC, laptop, tablet PC, or other mobile computing device.

Pursuant to some embodiments and as introduced above, an Interface is a mechanism through which any functionality of the Email Exchange can be accessed. A list of some Interfaces available from the Email Exchange includes:
all Delivery Channels;
an applet/Add-in, including precompiled program code provided by the Email Exchange service that can be combined/linked with other third-party web sites (though not necessarily developed or maintained by the Email Exchange); and
API (application programming interface).

The following table includes a number of Interfaces provided and utilized in some embodiments, where some features of the various interfaces are also listed.

| | | | Mailing | | Subscriber | | Advertiser | |
|---|---|---|---|---|---|---|---|---|
| | Basic | Reverse | List | | Account | Record | Account | Record |
| Interface | Lookup | Lookup | View | Maintenance | Maintenance | Maintenance | Maintenance | Maintenance |
| Web Page | Yes | Yes | Yes | Yes | Yes | Yes | Yes | Yes |
| Toolbar | Yes | Yes | Yes | No | No | No | No | No |
| Widget | Yes | Yes | Yes | No | No | No | No | No |
| Gadget | Yes | Yes | Yes | No | No | No | No | No |
| PDA | Yes | Yes | Yes | No | No | No | No | No |
| Pocket PC | Yes | Yes | Yes | No | No | No | No | No |
| Smartphone | Yes | Yes | No | No | No | No | No | No |
| Applet | Yes | Yes | Yes | Yes | No | No | No | No |
| Add-in | Yes | Yes | Yes | Yes | No | No | No | No |
| API | No | No | No | No | No | Yes | No | Yes |

More detail for each of these can be found below.

Pursuant to some embodiments, each Delivery Channel should have a consistent user interface and “look and feel”, including online or web links to online documentation related to the Email Exchange. Some of the components and features that may contribute to providing a consistent “look and feel” for the various user interfaces include:
an “About” page, including information about the site, what it offers and general self promoting marketing material;
a “Contact” page for reaching the various departments at the Email Exchange application, system, or service provider;
a “Legal” page, including relevant legal material for each service offered by the Email Exchange, such as:
   an EULA (end-user license agreement)/Disclaimer for each Delivery Channel;
   an EULA/Disclaimer for each Applet/Add-in;
   an EULA/Disclaimer for each API;
   subscriber Agreement/Terms and Conditions;
   Advertiser Agreement/Terms and Condition;
      Subscriber Data Agreement/Terms and Conditions; and
      General Data Agreement/Terms and Conditions.

Pursuant to some embodiments, interfaces, other than a Delivery Channel provided by the Email Exchange, may have access to the same documentation and may be required to make the information available in a style and format that is specified by the Email Exchange.

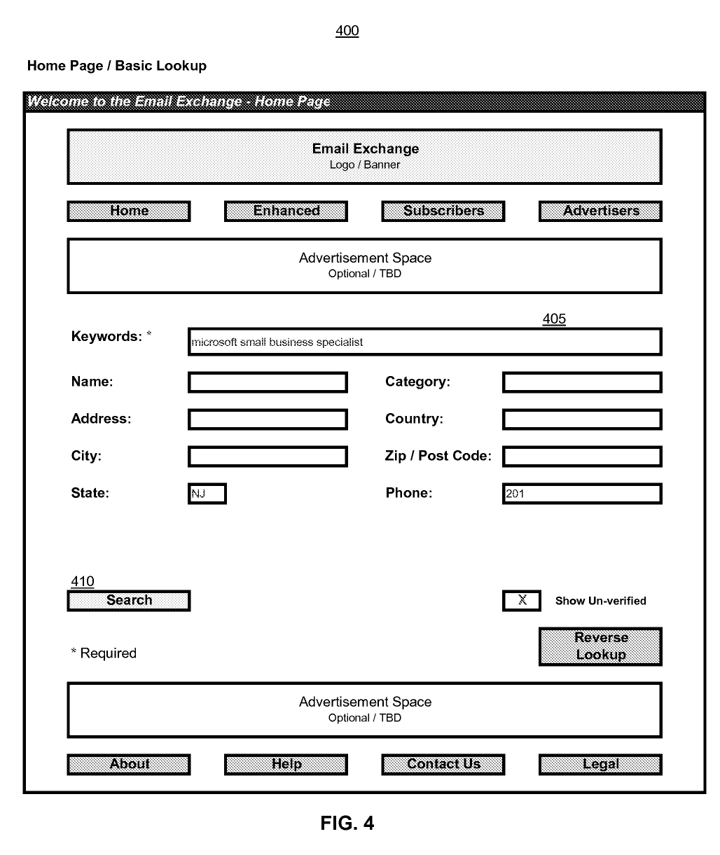

FIG. 4 is an illustrative example of a web page 400 offering, for example, a home page basic lookup functionality. As illustrated, various buttons/icons are provided for a user to return to a home page (shown), log in as an Enhanced user, a Subscriber, and an Advertiser. In particular, a window 405 is provided for a user to enter keywords in order to submit a query against the records maintained by the exchange database. A search button 410 is provided to initiate the query.

Electronic Records

Pursuant to some embodiments, an Electronic Record is a collection of data that represents a single, though not necessarily a unique electronic destination. In accordance herewith, each “Active” electronic record may be linked to one (and only one) “Active” subscriber. The data elements of an electronic record may include:

| | | | System |
|---|---|---|---|
| Field | Description | Required | Field |
| Full Name | First, Middle, Last Name | Personal/ | |
| | | Family - Yes | |
| | | Business - | |
| | | No | |
| Company | Business Name | Personal/ | |
| Name | | Family - No | |
| | | Business - | |
| | | Yes | |
| Mailing | Street Address, City, State/Country, Zip/Postal Code | Yes | |
| Address | | | |
| Telephone | Telephone number including country code and area code | | |
| Email | Email address with fully qualified domain name | Yes | |
| Text | Text message address | | |
| Address | | | |
| IM Address | Instant messaging address | | |
| Web Page | Web Page URL with fully qualified domain name | | |
| Category | Fixed form general category of this record (e.g. Personal, | Yes | |
| | Financial, Government, Consumer Products, Industrial, etc). This | | |
| | list will be primed with a set of categories (to be determined) and | | |
| | evolve over time | | |
| Keywords | Detailed and specific keywords to distinguish this record from | Yes | |
| | others that fall into the same category | | |
| Optional | Free form text related to the record | | |
| Text | | | |
| Graphic/ | A graphic logo (e.g. JPB, TIF, EPS, etc) associated with the owner | | |
| Logo | of the record (e.g. company logo, icon, picture, character, etc.) | | |
| Subscriber | The subscriber responsible for providing and maintaining this | Yes | Yes |
| ID | record | | |
| Status | A status indicating whether the record is Active or In-active or Un- | Yes | Yes |
| | verified | | |
| Last Update | A Date &Time stamp for when this record was last updated | Yes | Yes |
| Record ID | A unique identifier for this Record | Yes | Yes |

In addition to being logged by the system, in some embodiments, all modifying actions performed to an Electronic Record (e.g., Add, Modify, and Delete actions ton electronic record) are emailed to the address on file for the Subscriber who owns the record, in order to obtain a confirmation that the modifying actions are authorized and/or actually wanted by the owner. The electronic records may be maintained in electronics records database 250 shown in FIGS. 2 and 3.

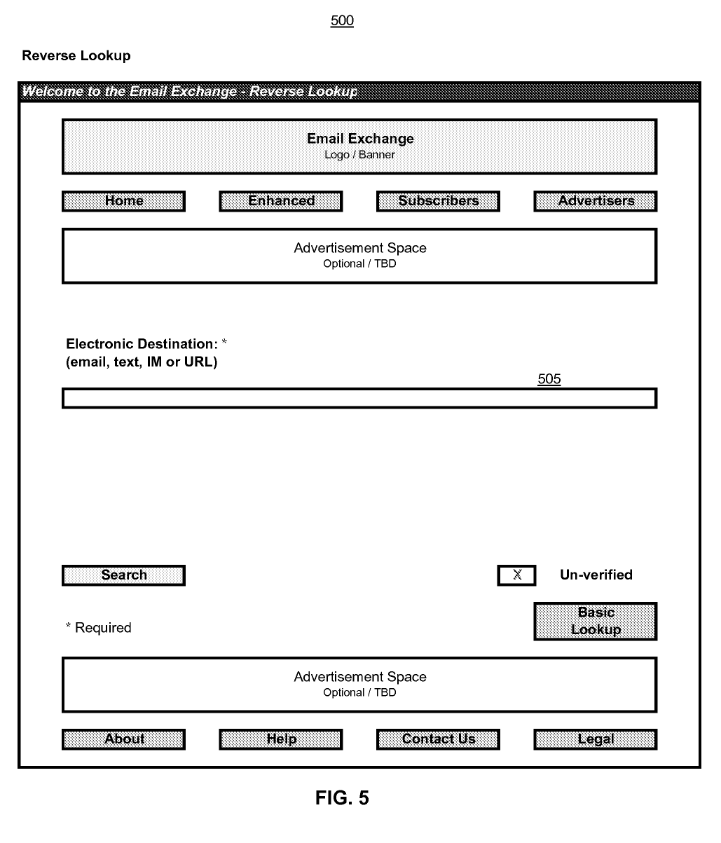

FIG. 5 is an illustrative example of a web page 500 providing, for example, a mechanism for a reverse lookup functionality. As illustrated, an email address, text string, IM address, or URL may be entered at 505 to request the exchange database to perform a reverse lookup against the electronic records, such as those described above.

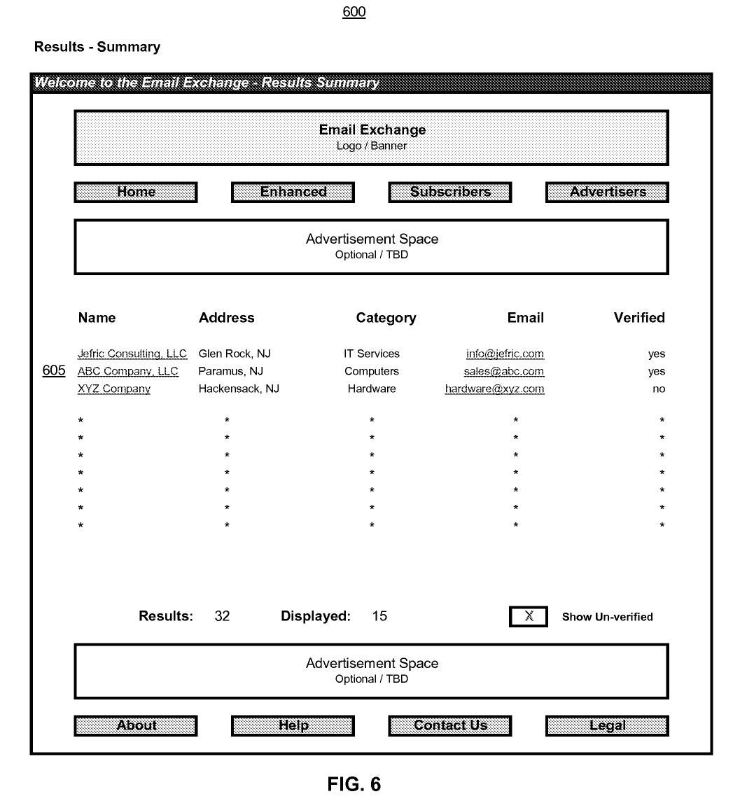

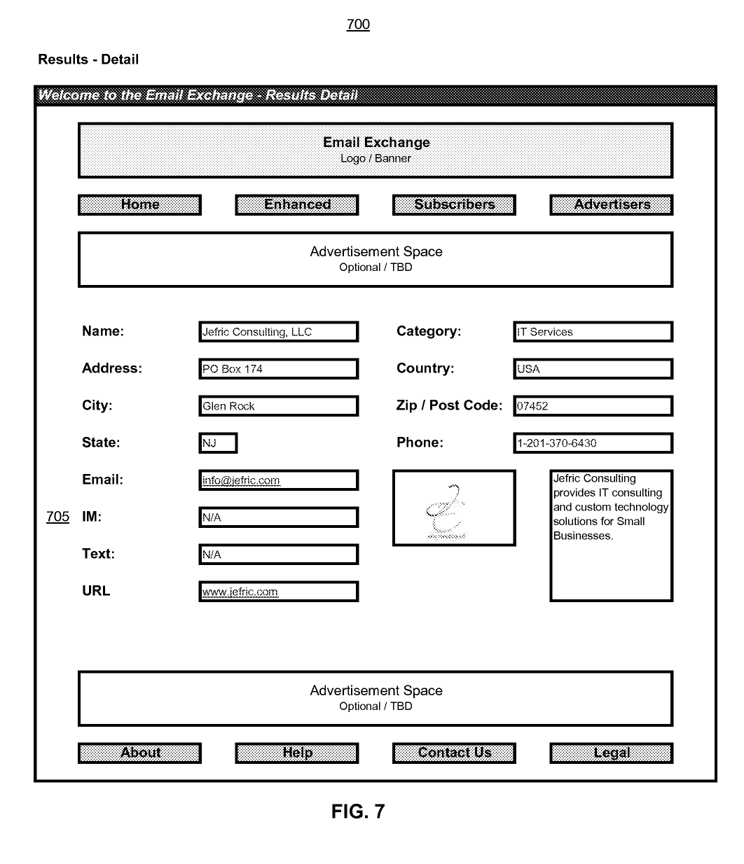

FIG. 6 is an illustrative example of a web page 600 depicting results of a query, for example a basic query or a reverse lookup where more than one result is returned. As illustrated, 3 are displayed at 605 in a Summary display format. Upon selection of one of the summarized results, a detail presentation may be provided as illustrated in FIG. 7, screen shot 700. As illustrated, the details (i.e., individual fields) of the contact listing are fully shown.

Users

As used herein, associated with the exchange database disclosed herein and pursuant to some embodiments, a User is a consumer of electronic records that have been collected and stored by the Email Exchange, and may be accessed by the basic user through one of the Interfaces discussed herein. In some embodiments, basic user access to the exchange database associated site is anonymous and does not require any specific data to be created or stored. The User records may be maintained in User records database 255 shown in FIGS. 2 and 3.

Pursuant to some embodiments, associated with the exchange database disclosed herein and pursuant to some embodiments, as used herein, an Enhanced User is a User who may also create and maintain one or more Mailing List. An Enhanced User may first create an account on the Email Exchange site (further discussed in association with Mailing Lists below).

Further pursuant to some embodiments, a User has access to the following functionality
submit a query;
modify a query;
view results;
cut and paste results into an Email client; and
create, an Enhanced User account, wherein the account may be initially marked pending and a confirmation email is sent to the email address supplied with a web link back to the Email Exchange site for confirmation and activation.

Pursuant to some embodiments, an Enhanced User has access to the following functionality and capability:
login to a Enhanced User account;
view, modify, or delete an Enhanced User account once logged in. Modifications to an Enhanced User account may be initially limited to the “Contact Name”. In some embodiments, the User login may not be updated/modified and requires deleting and re-creating the Enhanced User account if desired;
view all saved Mailing Lists (requires log in);
view, create, update, and delete a single Mailing List (requires log in);
cut and paste the contents of a Mailing List from the Delivery Channel into an email client for composing and sending a message; and
logout of an Enhanced User account (requires a log in).

Pursuant to some embodiments, the data elements of a user record in accordance herewith may include the following fields:

| | | | System |
|---|---|---|---|
| Field | Description | Required | Field |
| Full Name | First, Middle, Last Name | Personal/ | |
| | | Family - Yes | |
| | | Business - | |
| | | No | |
| Company | Business Name | Personal/ | |
| Name | | Family - No | |
| | | Business - | |
| | | Yes | |
| Mailing | Street Address, City, State/Country, Zip/Postal Code | Yes | |
| Address | | | |
| Telephone | Telephone number including country code and area code | | |
| Email | Email address with fully qualified domain name | Yes | |
| Text | Text message address | | |
| Address | | | |
| IM Address | Instant messaging address | | |
| Web Page | Web Page URL with fully qualified domain name | | |
| Category | Fixed form general category of this record (e.g. Personal, | Yes | |
| | Financial, Government, Consumer Products, Industrial, etc). This | | |
| | list will be primed with a set of categories (to be determined) and | | |
| | evolve over time | | |
| Keywords | Detailed and specific keywords to distinguish this record from | Yes | |
| | others that fall into the same category | | |
| Optional | Free form text related to the record | | |
| Text | | | |
| Graphic/ | A graphic logo (e.g. JPB, TIF, EPS, etc) associated with the owner | | |
| Logo | of the record (e.g. company logo, icon, picture, character, etc.) | | |
| Subscriber | The subscriber responsible for providing and maintaining this | Yes | Yes |
| ID | record | | |
| Status | A status indicating whether the record is Active or In-active or Un- | Yes | Yes |
| | verified | | |
| Last Update | A Date &Time stamp for when this record was last updated | Yes | Yes |
| Record ID | A unique identifier for this Record | Yes | Yes |

The exchange database service, in some embodiments, does not permit having two Enhanced User accounts associated with the same “User” name. An attempt to create the second duplicate Enhanced User account will thus fail and prompt for a different “User” name.

In some embodiments, in addition to being logged by the system, all modifying actions performed to an Enhanced User account (e.g., Add, Modify, and Delete to the Account or a Mailing List) are emailed to the address on file as confirmation. It should be appreciated that this is just one example of one type or layer of security/fraud protection and other, alternative, and different security mechanisms may be used with the present exchange database.

In some embodiments, Enhanced User accounts that have not been accessed (e.g., logged into) for over an extended period of a time may be marked “in-active”, causing a confirmation email sent to the address on record. The extended period of time may be configured, by a system administrator for example, to be a period of six(6) months. The account may be re-activated at a next successful login made during a subsequent six (6) months.

Further, in some embodiments, Enhanced User accounts that have been marked in-active for greater than six(6) months or other designated time may be removed from the system and a confirmation email may be sent to the address on record. Upon removal from the system, any Mailing Lists associated with the Enhanced Userwill also be removed.

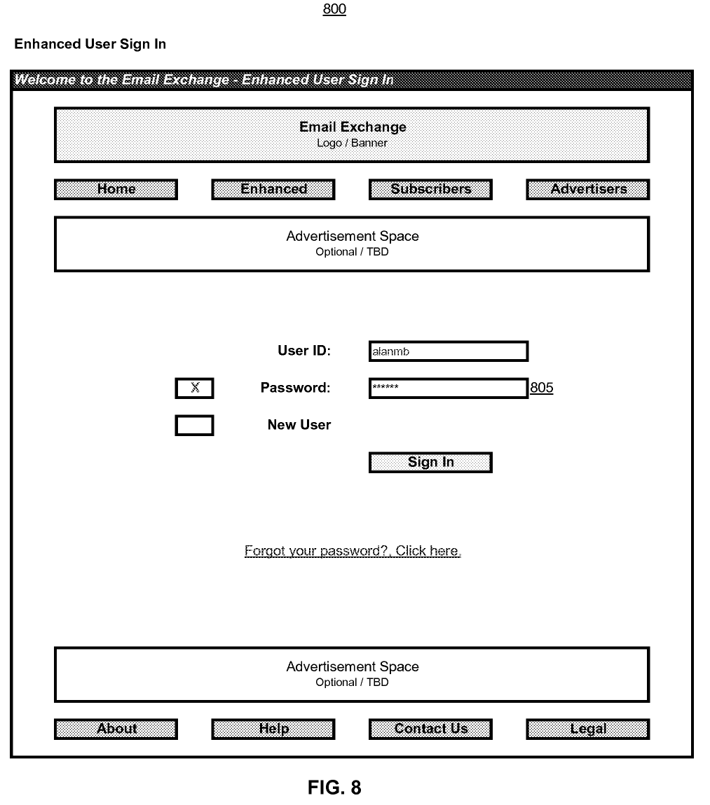

FIG. 8 is an illustrative example of a screenshot 800 providing, for example, a view of an Enhanced User sign in page. As indicated, the Enhanced User may sign in by providing their ID and password at 805.

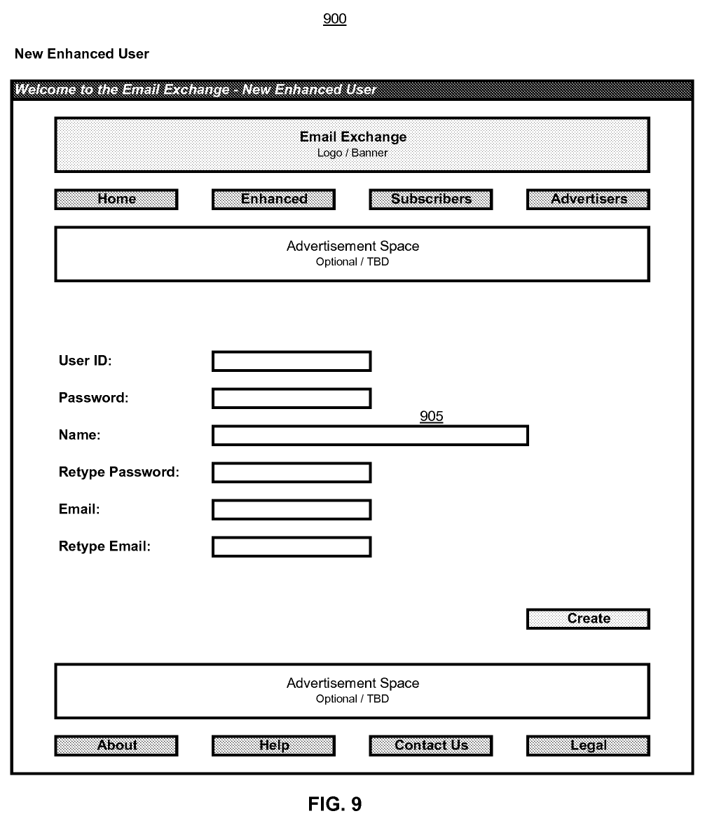

FIG. 9 is an illustrative example of a screenshot 900 providing, for example, a view of a New Enhanced User data entry page. As indicated, the new Enhanced User may enter their desired ID, password, and email contact at 905. Screen 900 may be invoked to initially sign up Enhanced Users and/or modify the Enhanced User's information.

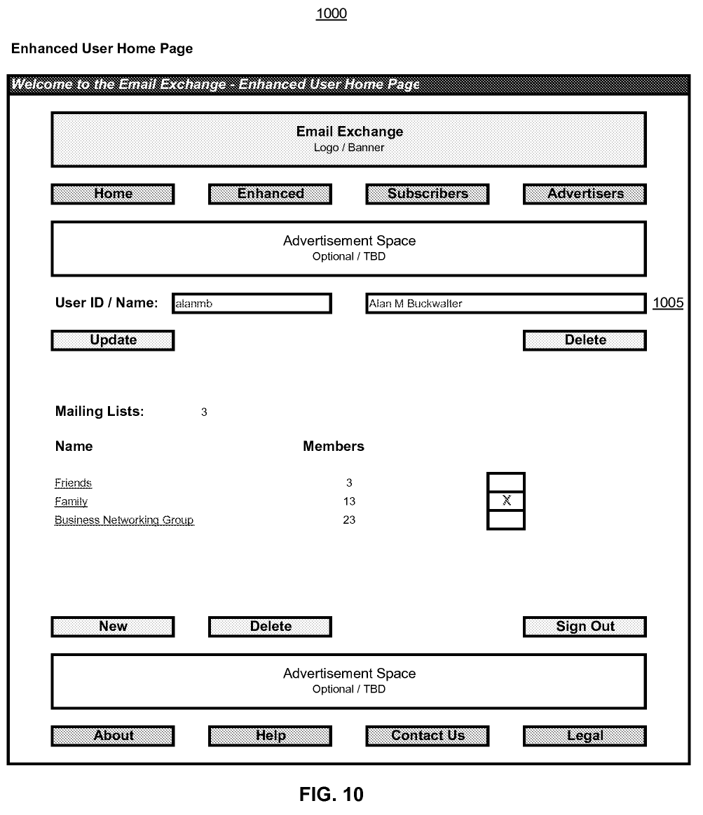

FIG. 10 is an illustrative example of a screenshot 1000 providing, for example, a view of an Enhanced User Home page. As indicated, the Enhanced User may update or delete their enhanced user account and create or delete a mailing list associated with the Enhanced User.

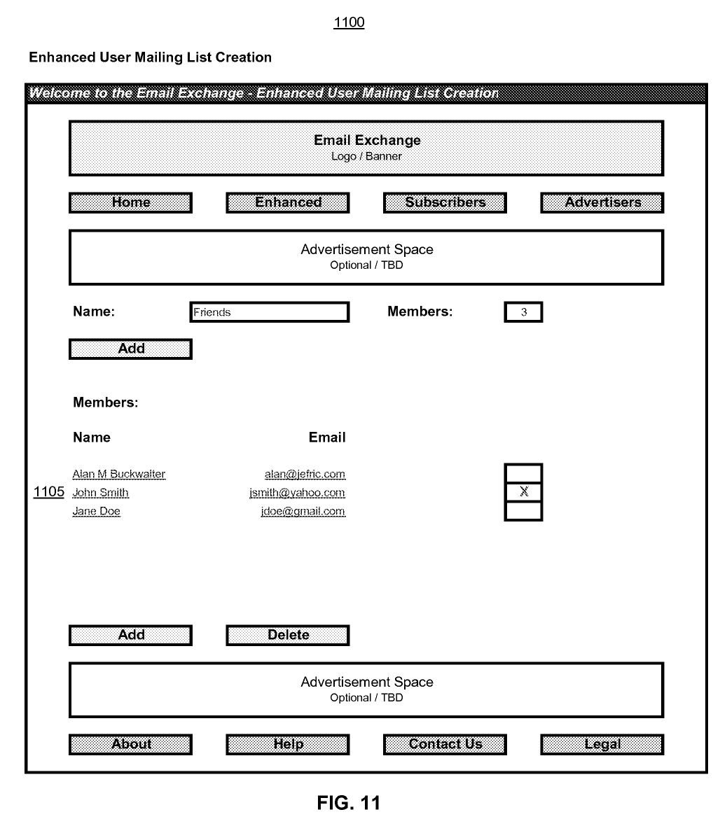

FIG. 11 provides a mechanism via screenshot 1100 for an Enhanced User to create a mailing list by providing names and corresponding email addresses to populate the Enhanced User's mailing list.

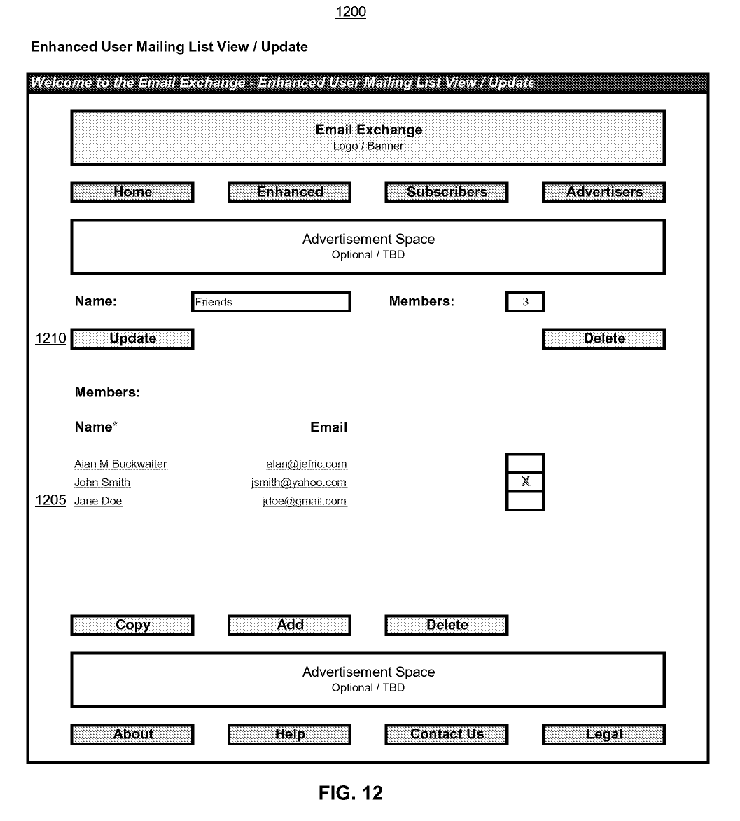

FIG. 12 is an illustrative example of a screenshot 1200 providing, for example, a view of a New Enhanced User View/Update page. As indicated, the Enhanced User may update mailing list 1205 entries by selecting Update button 1210.

Subscribers

As used herein, the term Subscriber refers to a supplier of electronic records which are collected and stored by the Email Exchange as introduced above. A subscriber can have zero or more electronic records linked to (associated with) them. In some embodiments, each “Active” electronic record is linked to an “Active” subscriber. The Subscriber records may be maintained in Subscriber records database 265 shown in FIGS. 2 and 3.

Pursuant to some embodiments, a Subscriber may perform the following functionality:
create a Subscriber account, in come aspects, the account is initially marked “Pending” and a confirmation email is sent to the email address supplied with a web link back to the Email Exchange service for confirmation and activation;
login to a Subscriber account;
modify Subscriber account information (requires log in);
view, create, modify, and delete Electronic Records associated the Subscriber account (requires log in);
export/download a list (e.g., a CSV text file) of Electronic Records associated with this Subscriber account;
view billing information related to the Subscriber activity; summary and detail, current billing period and historical (requires log in)
make payments related to the Email Exchange incurred by the Subscriber activity;
logout of a Subscriber account (requires log in); and
remove a Subscriber account—must be logged in

In addition to being logged by the system, in some embodiments, all modifying actions performed to a Subscriber account (e.g., add, modify, and delete) are emailed to the address on file as confirmation. In some embodiments, actions performed through the API are reported in a bulk report at the end of the day, also delivered by email.

Subscriber account creation and maintenance, in some embodiments, may be performed online using the Web browser Delivery Channel. In some instances, there may initially be no API access for Subscriber accounts.

In some embodiments, any Subscriber action to an account or electronic record will automatically generate the necessary transaction detail and history required by the Billing process. In this manner, sufficient records are established to substantiate billing functions.

Pursuant to some embodiments, the data elements of a Subscriber record include:

| | | | System |
|---|---|---|---|
| Field | Description | Required | Field |
| User | A unique name used by the subscriber to access the service (web | Yes | |
| | page) | | |
| Password | Password associated with the User name | Yes | |
| Subscriber | Individual, Family, Business | Yes | |
| Type | | | |
| Full Name | First, Middle, Last Name of the subscriber primary contact | Yes | |
| Company | Business Name | Personal/ | |
| Name | | Family - No | |
| | | Business - Yes | |
| Mailing Address | Street Address, City, State/Country, Zip/Postal Code | Yes | |
| Billing Address | Street Address, City, State/Country, Zip/Postal Code | Yes | |
| Telephone | Telephone number including country code and area code | Yes | |
| Email | Email address of the subscriber primary contact | Yes | |
| Payment | Method of payment to be received from subscriber for active | Yes | |
| Method | records | | |
| Account | Account being charged for payment | Yes | |
| Information | | | |
| Signature on | Yes or No - Required for credit card and other billing purposes | Yes | |
| file | | | |
| API | Is this subscriber a user of the API for programmatically changing | Yes | |
| | electronic records that they own - Yes/No | | |
| Status | A status indicating whether the subscriber is Pending, Active or In- | Yes | Yes |
| | active. | | |
| Last Login | A Date &Time stamp for when the user last logged into this account | Yes | Yes |
| Last Update | A Date &Time stamp for when this record was last updated | Yes | Yes |
| Subscriber ID | A unique identifier for this Subscriber | Yes | Yes |

In some embodiments, the system may not permit having two Subscriber accounts associated with the same “User” name. The attempt to create the second Subscriber account will fail, and prompt for a different “User” name.

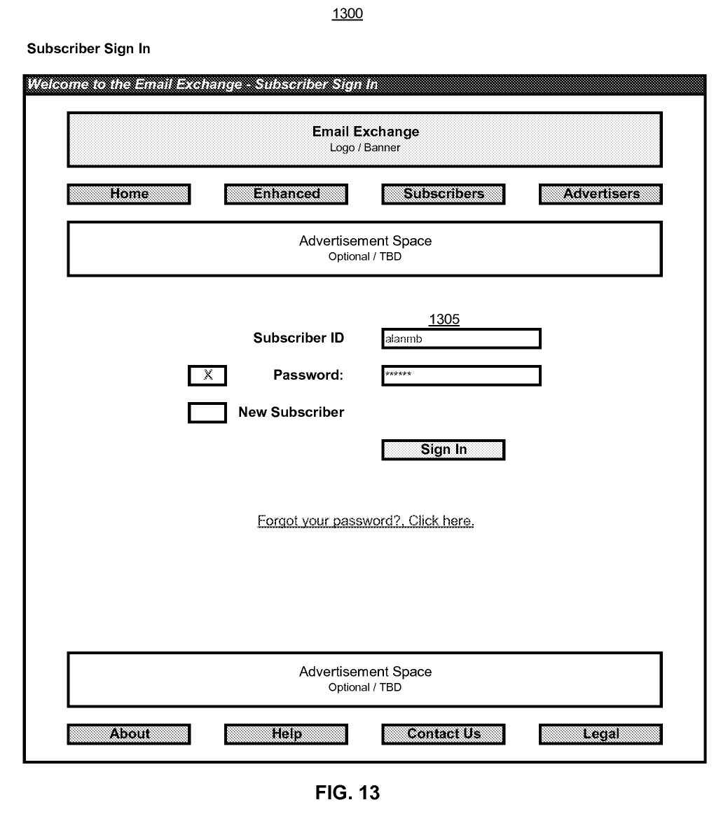

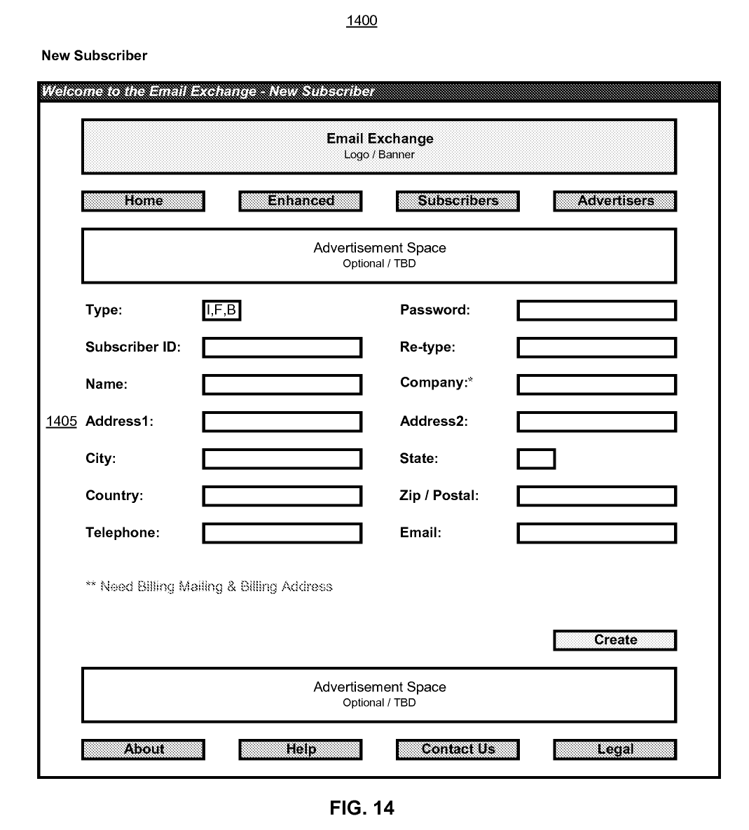

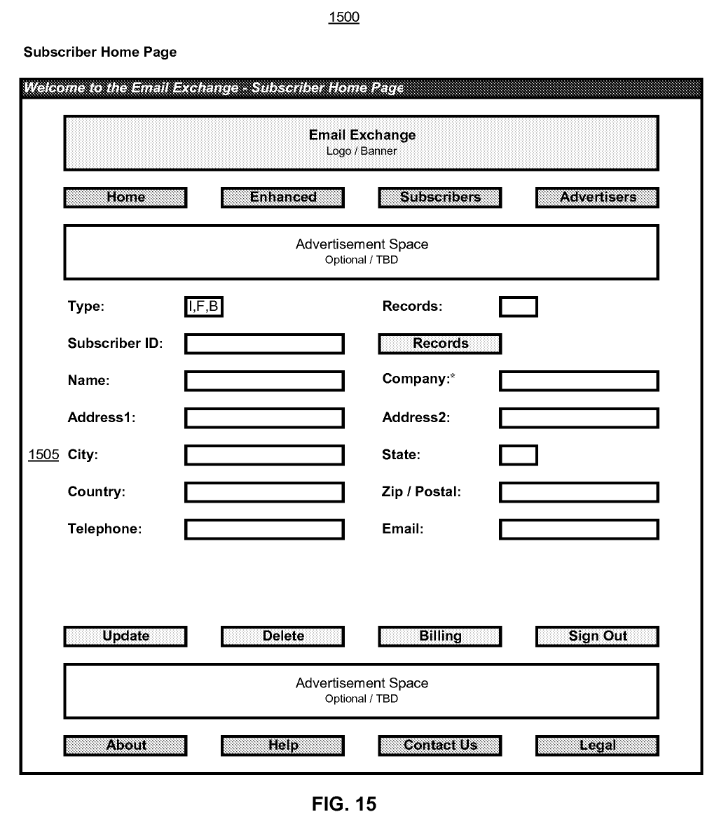

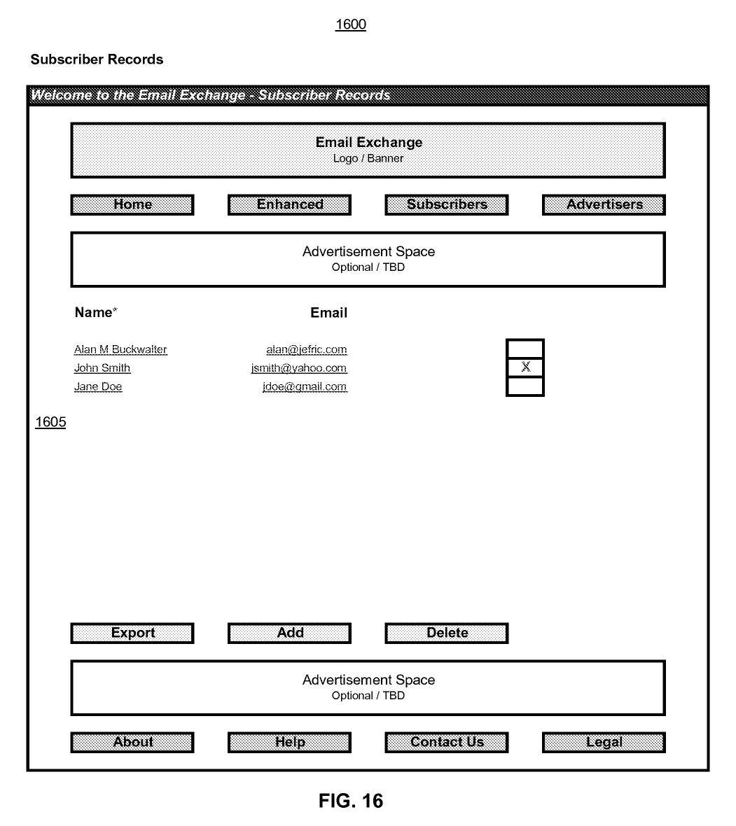

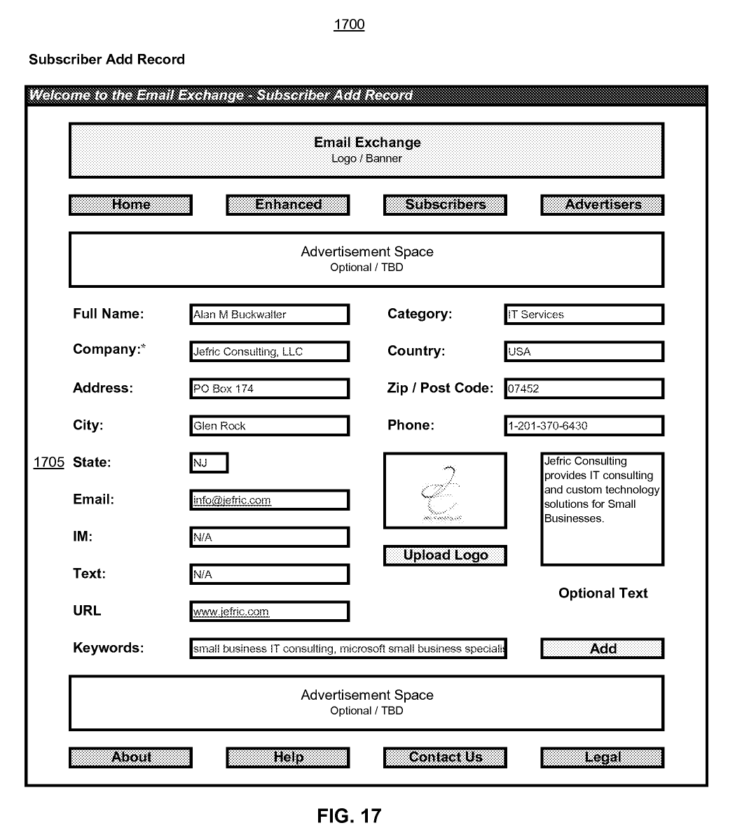

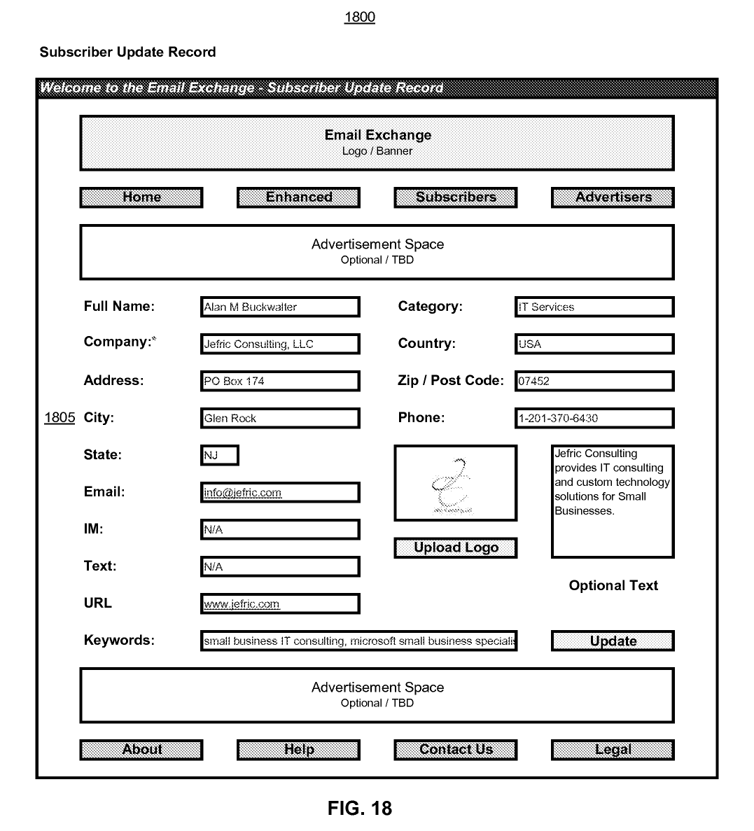

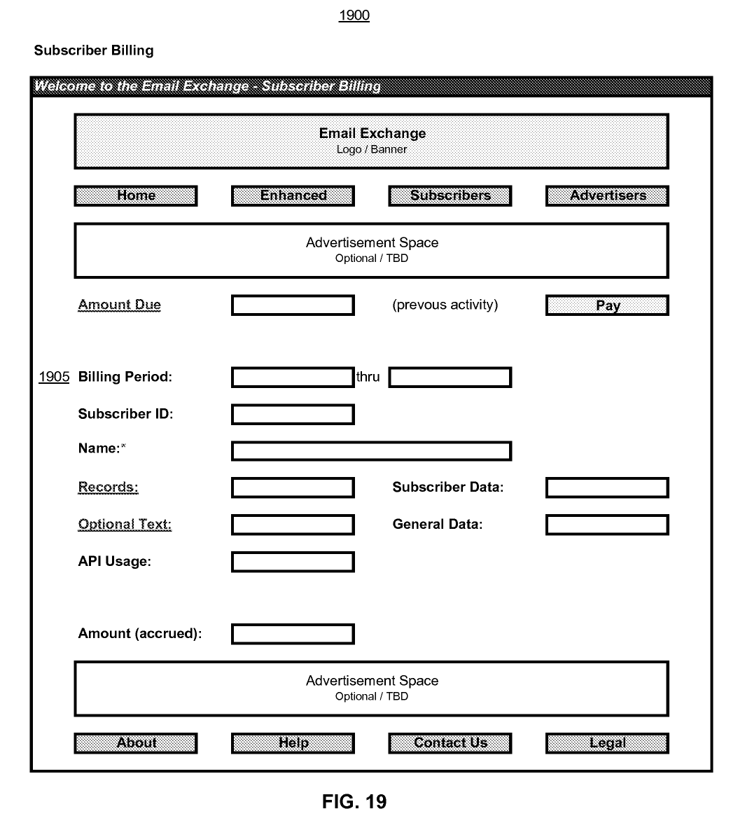

FIGS. 13-19 are illustrative examples of a screenshots 1300-1900 providing exemplary mechanisms for supporting Subscriber actions. FIG. 13 relates to a Subscriber sign in page, including data entry locations 1305 for the Subscribers log in information. FIG. 14 relates to a New Subscriber page and includes data entry locations 1405 for the all of the Subscribers contact information. FIG. 15 relates to a Subscriber Home page. It is noted that the Subscriber and the Enhanced home page of FIG. 10 are similar in overall layout and configuration. Such similarities benefit users by providing a consistent user interface experience. FIG. 16 relates to a Subscriber and provides an example of Subscriber record listings at 1605 of screenshot 1600. FIG. 17 relates to a Subscriber page that supports adding a record in the various fields shown at 1705 of screenshot 1700. FIG. 18 relates to a Subscriber Update page, including data entry locations 1805 for the Subscribers to update their contact information. FIG. 19 relates to a Subscriber billing page, including data entry locations 1905 for the Subscribers to enter billing relevant information.

Advertisers

As used herein, the term Advertiser refers to a supplier of content that is presented to end-users of the Email Exchange service through any one of the Interfaces, in exchange for a payment. Advertiser content is included with all Interfaces of the Email Exchange. Advertiser billing may require a count of (1) the number of imprints; (2) the number of click-thrus; and (3) the number of conversions or sales that result from the click-thru. The Advertiser records may be maintained in Advertiser records database 260 shown in FIGS. 2 and 3.

Pursuant to some embodiments, an Advertiser has access to the following functionality:
Create an Advertiser account—The account is initially marked Pending, a confirmation email is sent to the email address supplied with a web link back to the Email Exchange site for confirmation and activation.
Login to an Advertiser account
modify Advertiser account information (requires log in);
view, create, modify, and delete content associated the Advertiser account (requires log in);
view billing information related to the Advertiser activity, such as summary, detail, current billing period, and historical data (requires log in);
make payments related to the Email Exchange incurred by the Advertiser activity;
logout of an Advertiser account (requires log in); and
remove a Advertiser account (requires log in).

In addition to being logged by the system, in some embodiments, all modifying actions performed to an Advertiser account (e.g., add, modify, and delete) may be emailed to the address on file as confirmation. Actions performed through the API are reported in a bulk report at the end of the day, may also delivered by email.

In some embodiments, Advertiser account creation and maintenance can only be performed online using the Web browser interface. Advertiser content creation and maintenance can be performed online as well as through the Advertiser API.

Any Advertiser action to an account or content will, in some embodiments, automatically generate the necessary transaction detail and history required by the Billing process.

Pursuant to some embodiments, the data elements of an advertiser record include:

| | | | System |
|---|---|---|---|
| Field | Description | Required | Field |
| User | A unique name used by the advertiser to access the service (web | Yes | |
| | page) | | |
| Password | Password associated with the User name | Yes | |
| Full Name | First, Middle, Last Name of the advertiser primary contact | Yes | |
| Company Name | Business Name | Yes | |
| Mailing Address | Street Address, City, State/Country, Zip/Postal Code | Yes | |
| Billing Address | Street Address, City, State/Country, Zip/Postal Code | Yes | |
| Telephone | Telephone number including country code and area code | Yes | |
| Email | Email address of the subscriber primary contact | Yes | |
| Payment Method | Method of payment to be received from subscriber for active records | Yes | |
| Account | Account being charged for payment | Yes | |
| Information | | | |
| Signature on file | Yes or No - Required for credit card and other billing purposes | Yes | |
| Status | A status indicating whether the advertiser is Active or In-active | Yes | Yes |
| Last Login | A Date &Time stamp for when the user last logged into this account | Yes | Yes |
| Last Update | A Date &Time stamp for when this record was last updated | Yes | Yes |
| Advertiser ID | A unique identifier for this Advertiser | Yes | Yes |

In some embodiments, advertising content may have a fixed size and format and displayed with an optional Advertiser specified weighting (e.g. display Ad #1 is displayed twice as often as Ad #2). Advertiser content may optionally be context sensitive, presented as a result of a query for a specific category, keyword, or other search variable.

The data elements of advertiser content include a number of data fields identifying and defining advertiser items of content.

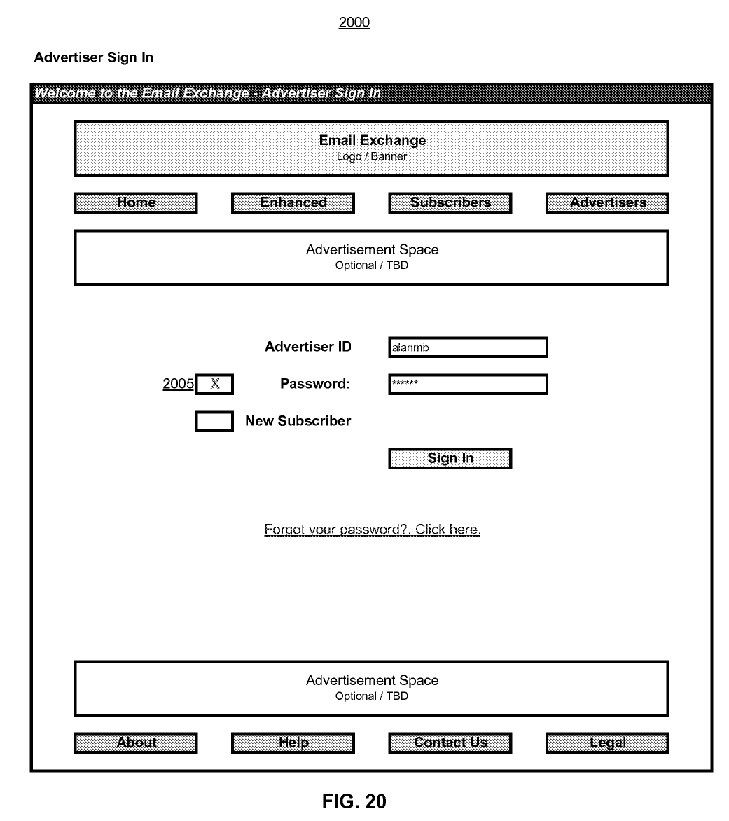

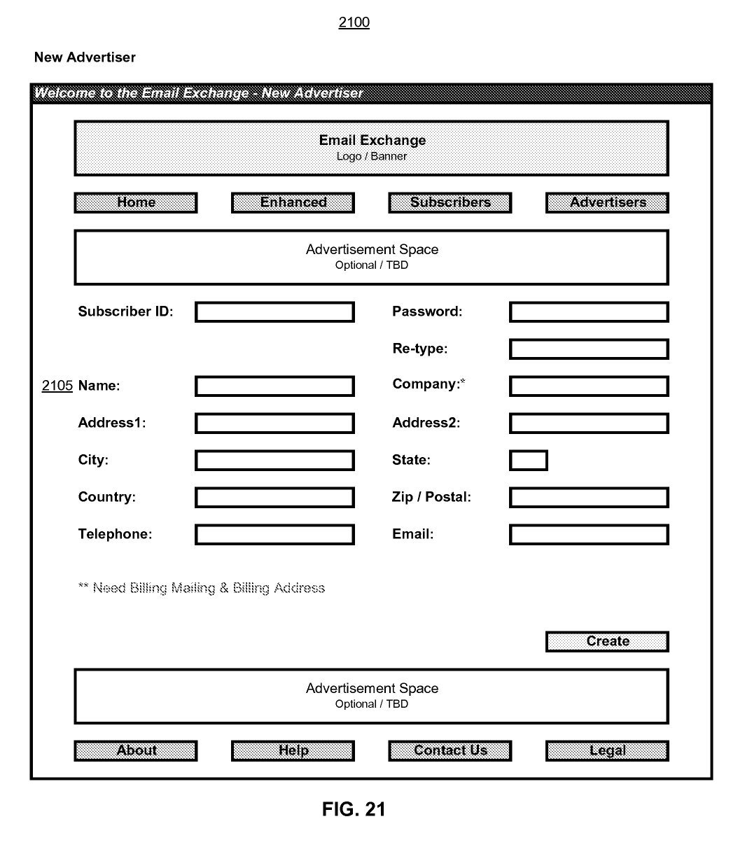

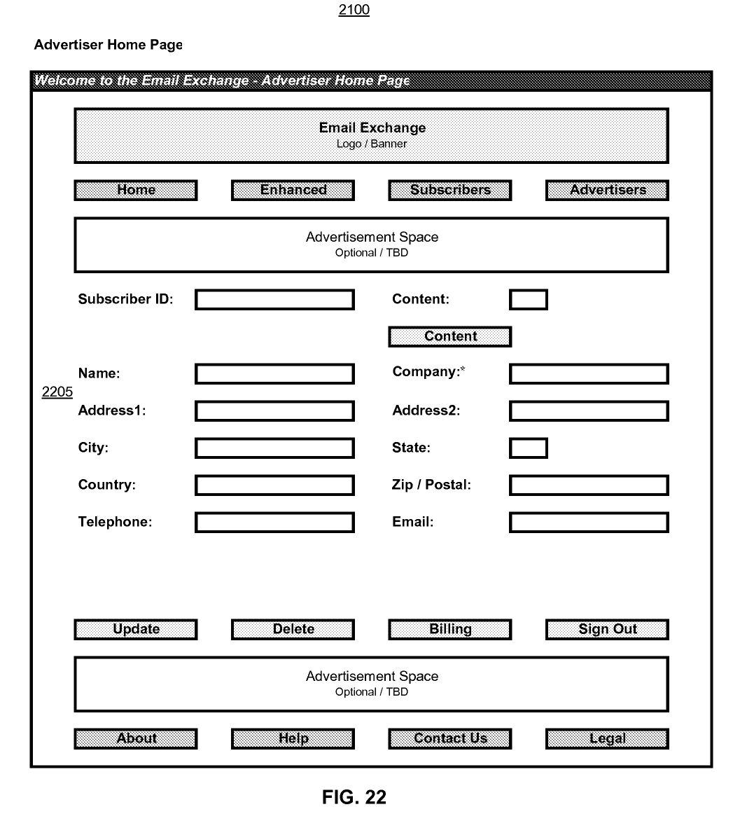

FIGS. 20-22 are illustrative examples of a screenshots 2000-2200 providing exemplary mechanisms for supporting Advertiser actions. FIG. 20 relates to a Subscriber sign in page, including data entry locations 2005 for the Advertisers log in information. FIG. 21 relates to a New Advertisers page and includes data entry locations 21005 for the all of the Subscribers contact information. FIG. 22 relates to an Advertisers Home page. Like other illustrated home page, the Advertiser home page is similar to those already discussed in overall layout and configuration.

API's

Subscriber API

As used herein, the term Subscriber API is a programmatic interface used by Subscribers of the Email Exchange for adding, updating and removing electronic records that they supply. The Subscriber API is provided as a JAVA library, VC++DLL, COM Object, and UNIX/Linux Shared Library. Other platforms and environment may be offered based on demand or at a fee to the Subscriber making the request.

In some embodiments, the Subscriber API will provide the Subscriber with the following functionality:
login to a Subscriber account;
retrieve, create, modify, and delete Electronic Records associated the Subscriber account (requires log in); and
logout of an Subscriber account (requires log in)

In some embodiments, any Subscriber API action to an electronic record may trigger a billing event. The event will snapshot all billing information since the last Subscriber action (including API) or start of a billing cycle up to the change.

In some embodiments, the data elements required for access to and by the Subscriber API include:

Advertiser API

As used herein, the term Advertiser API refers to a programmatic interface used by Advertisers of the Email Exchange for adding, updating and removing content that they supply to the exchange database. The Advertiser API may be provided as a JAVA library, VC++DLL, COM Object, and UNIX/Linux Shared Library. Other environments may be offered based on demand or at a fee to the Advertiser making the request.

In some embodiments, the Advertiser API will provide the Advertiser with the following functionality:
login to a Advertiser account;
retrieve, create, modify, and delete content associated the Advertiser account—once logged in; and
logout of an Advertiser account (requires log in).

Pursuant to some embodiments, the data elements required for access to and by the Advertiser API include:

| | | | System |
|---|---|---|---|
| Field | Description | Required | Field |
| User | A unique name used by the subscriber to access the service via the API | Yes | |
| Password | Password associated with the User name | Yes | |
| Subscriber ID | The subscriber responsible for providing and maintaining this record | Yes | Yes |
| Cost | Dollar amount charged to the Subscriber for using the Subscriber API | Yes | |
| Status | A status indicating whether the subscriber API access is Active or In-active | Yes | Yes |
| Last Login | A Date &Time stamp for when the user last logged into this account | Yes | Yes |
| Last Update | A Date &Time stamp for when this record was last updated | Yes | Yes |

In an effort to control costs, Advertisers may have the ability to opt-in or opt-out of using each Interface, performed through the Account update functionality.

Mailing Lists

In some embodiments, the Email Exchange allows Enhanced Users to create and maintain mailing list(s) of Individuals, Family & Companies contacts that are automatically translated into a current list of email addresses that can be cut & pasted into an email client. In some embodiments, the ability to send email directly from the Email Exchange service may be prevented for security and spam control reasons. In some other aspects, should an email address or other electronic contact information of a contact listing change then the information presented to the user may be automatically adjusted with the most current information. Mailing List records may be maintained in the electronics records database 240 shown in FIGS. 2 and 3.

In one illustrative embodiment, a limit of 15 (configurable) mailing lists per Enhanced User may be provided or supported, each with a limit of 99 (configurable) contacts.

In some embodiments, access to mailing lists (viewing, creating, updating, etc) may initially be available through a web browser.

In some embodiments, the data elements associated with a Mailing List may include:

| | | | System |
|---|---|---|---|
| Field | Description | Required | Field |
| Mailing List Name | A unique name (per user) for this mailing list | Yes | |
| Record ID(s) | One or more electronic record that is part of this mailing list | Yes | |
| Status | A status indicating whether the subscriber is Active or In-active | Yes | Yes |
| Last Login | A Date &Time stamp for when the user last logged into this account | Yes | Yes |
| Last Update | A Date &Time stamp for when this record was last updated | Yes | Yes |
| User ID | A unique identifier for this User | Yes | Yes |

Data

Regarding data utilized by the exchange database, the data may include subscriber data and generic data, each of which are discussed in greater detail below.

Subscriber Data

Pursuant to some embodiments, while there are many permutations of data that may be requested and ultimately provided, usage data tracking the number of times that an electronic record was in the result set or returned to a user of the Email Exchange and the details of the originating query may be captured. The Subscriber records may be maintained in Subscriber records database 265 shown in FIGS. 2 and 3. The data may be offered to Subscribers in a raw, un-aggregated format and may be combined with information from other parts of the system. In further accordance with some embodiments, the Subscriber Data that is captured during every user query may include:

| Field | Description | Required |
|---|---|---|
| Record ID | The unique identifier of the record that was presented to the user. | Yes |
| Subscriber ID | The unique identifier of the subscriber that owns the record | Yes |
| Keyword | As supplied by The Email Exchange user | Yes |
| Result Set Size | The number of records returned from the query | Yes |
| Returned to the user | Was the result returned to the user (or was the result set too large?) - Yes/No | Yes |
| Click-thru | Did the user click on the web page URL? - Yes/No | Yes |
| Timestamp | Date &time the query was made | Yes |
| Host | Host name and IP address of the user who made the query | Yes |
| Interface | The delivery channel used by the query | Yes |
| OS | Operating system of the device making the query | Yes |

In some embodiments, Subscriber Data may be made available through a secure FTP site as a date stamped file. A unique login and password may be supplied by the Email Exchange at the time the Subscriber signs up to receive the data. A maximum of six(6) months or some other determined time of data may be accessible on the FTP site, where the data is maintained and purged on a last in, first out basis.

Generic Data

As used herein, the term Generic Data is defined as usage data of the Email Exchange service (e.g. the number of times that a category or keyword was requested, and if supplied, the location/region, etc) may not be linked back to the Subscriber who supplied it. The generic data may be provided in a raw, un-aggregated format and can be combined with information from other parts of the system, but will not have any Subscriber identifying marks or attributes. In some embodiments, this data will be offered to the general public.

The Generic Data that is captured during every
user query will, in some embodiments, include:

| Field | Description | Required |
|---|---|---|
| Category | As supplied by The Email | Yes |
| | Exchange user | |
| Keyword | As supplied by The Email | Yes |
| | Exchange user | |
| City | As supplied by The Email | Yes |
| | Exchange user | |
| State | As supplied by The Email | Yes |
| | Exchange user | |
| Zip/Postal Code | As supplied by The Email | Yes |
| | Exchange user | |
| Result Set Size | The number of records return | Yes |
| | from the query | |
| Click-thru | Did the user click on the web | Yes |
| | page URL? - Yes/No | |
| Timestamp | Date &time the query was | Yes |
| | made | |
| Host | Host name and IP address of | Yes |
| | the user who made the query | |
| Interface | The delivery channel used by | Yes |
| | the query | |
| OS | Operating system of the | Yes |
| | device making the query | |

In some embodiments, Generic Data may be made available through a secure FTP site as a date stamped file. A unique login and password may be supplied by the Email Exchange at the time customer signs up to receive the data. If the customer is also receiving Subscriber data, the same login and password may be used. In some embodiments, a maximum of 6 months of data (LIFO) may be accessible on the FTP site.

Queries

A number of queries may be provided pursuant to some embodiments, including, for example, the following queries. Query data records may be maintained in Query data records database 270 depicted in FIGS. 2 and 3.

Basic Lookup Queries

Inputs—One or more keyword plus any combination of the following Electronic Record data elements.
category
full Name
company Name
telephone (zero or more of: country code, area code, prefix, extension),
address (zero or more of street, city, state, zip, postal code, country)

In some embodiments, all queries will support optional “Soundex Code” matching, to allow for abbreviations, spelling mistakes and other user errors. A user can toggle this feature on and off.

Regarding outputs, all matching Electronic Records may be provided in a summarized format. Selecting (e.g., clicking on) a specific record may present the user with a detailed format including all data elements for that record, with the exception of System Fields.

In some embodiments, the user may have the ability to filter out un-verified electronic records (see Web Crawler below).

In an effort to address identity, usage abuse, spam considerations, and other threats, user queries may not contain wild cards and may only return the first 15 (configurable) results. This may prevent abuse by generic queries that generate large results sets that can be copied or downloaded from the interface. For example: a query for everyone in zip code 10004 will only produce 15 records.

The query interface will detect a large number (configurable) of requests performed over a very short amount of time (configurable), force a delay (configurable) between subsequent requests and eventually prevent them over time. Repeated queries and other types of behavior may suggest an automated system or application that is attempting to extract records for purposes other than those offered by the Email Exchange, or some other abuse of the service.

Reverse Lookup Queries

In some embodiments, a User may have the ability to perform a reverse lookup, viewing the electronic record(s) that match a specified electronic destination, in the same output format as a Basic Lookup. A number of user interfaces may be provided to facilitate interaction with embodiments of the present invention.

Interfaces

Pursuant to some embodiments, End-users (i.e., users and subscribers) of the Email Exchange herein will have the ability to use a variety of Interfaces access the service. With the exception of a Web Browser, these Interfaces described below may be developed and supported by the Email Exchange at not cost to the user. Changes or other custom Interfaces may be evaluated on a per-request basis and may result in charges back to the requester. By way of example, the following set of user interfaces are illustrative of interfaces associated with the present disclosure. However, it should be appreciated that the following interfaces are not exhaustive of all possibilities.

Web Browse Interface

The Email Exchange Web Page will provide the following functionality:
all User functionality for both a Basic Lookup and Reverse Lookup;
all Enhanced User functionality;
all Subscriber functionality; and
all Advertiser functionality.

Toolbar, Desktop Gadget/Widget Interface

The Email Exchange browser Toolbar, and Desktop Gadget/Widget (including Windows, Macintosh, UNIX, Linux, etc) may provide the following functionality:
all User functionality for both a Basic Lookup and Reverse Lookup with the exception of creating an Enhanced User account; and
all Enhanced User functionality with the exception of creating, updating and deleting a Mailing List.

PDA/Pocket PC Interface

Two interfaces may be be available to PDA/Pocket PC users of the Email Exchange, including:
a web page with the same content and structure as described above, but reformatted for the smaller screen using the PDA/Pocket PC (built-in) web browser.
a downloadable application (for free) that runs natively on the PDA/Pocket PC without the need of a web browser
all User functionality for both a Basic Lookup and Reverse Lookup with the exception of creating an Enhanced User account
all Enhanced User functionality with the exception of creating, updating and deleting a Mailing List.

Smartphone or other mobile phone device Interface

In some aspects, two interfaces may be available to Smartphone users of The Email Exchange, including:
a web page with the same content and structure as described above, but reformatted for the smaller screen using the Smartphone (built-in) web browser;
a downloadable application that runs natively on the Smartphone without the need of a web browser; and
all User functionality for both a Basic Lookup and Reverse Lookup with the exception of creating an Enhanced User account.

Applet/Add-in Interface

The Email Exchange Applet/Add-in Interface may consist of precompiled application code provided by the Email Exchange that may be combined with third-party developed web sites. The application may be provided in a variety of formats and languages including, but not limited to: JAVA, ActiveX, etc. The functionality offered by this interface may include:
all User functionality for both a Basic Lookup and Reverse Lookup; and
all Enhanced User functionality

To preserve the integrity of the system in some instances, the Email Exchange may impose guidelines and usage requirements for these interfaces to insure that they are not used to abuse or degrade the Email Exchange service.

Logging

Pursuant to some embodiments, all actions performed against the data of the Email Exchange will be logged, with full historical data representation and transactions at every point in time. That is, every piece of data such as, for example, electronic records, subscribers, etc., may have all the information describing what is looked like at every point in time leading up to the current content. Any data removed/deleted from the service may be archived for a designated time (e.g., 5 years) in a parallel, active, offline database.

In some embodiments, all access to and actions performed with the services provided by the Email Exchange, including API access, may be logged, along with all applicable producer/consumer specific data and actions performed. This includes, but is not limited to an entity (user, subscriber, advertiser, etc) name, originating hostname and IP address, web browser, operating system, etc.

Billing

Pursuant to some embodiments, billing modules are provided to facilitate billing and settlement among participants. In some embodiments, there are four distinct billing categories associated with the Email Exchange:
Subscriber Billing;
Adverting Billing;
Subscriber Data; and
General data.

For example, billing may be performed monthly using the local calendar, days and time zone of the Email Exchange office headquarters. All billing may be derived based on End-user data, action and usage of the Email Exchange service. Should there be a need, system Logging and Support Tools (discussed below) may enable a member of the Email Exchange support staff or billing department to drill down into the details of the user's related logs (current and historical) of account, bill and contributing transactions.

Subscriber Billing

Subscriber billing, for example, may be performed monthly, based on the previous calendar month activity. This includes number of records, optional text character count, API usage and Data. Subscriber charges may be accrued daily based on the number and content (optional text) of Electronic Records linked to their account:
Record charges may be based on the maximum number of unique records associated with a Subscriber account over the course of a day. Discounts and other price breaks may be based on the minimum number of unique records associated with a Subscriber account over the course of a day.
Charges for optional text associated with contact listing records may be based on the maximum number of characters contained within an electronic record at any point in time over an entire day. Daily accruals are totaled at the end of the calendar month and applied to the Subscriber account balance pro-rata against the monthly billing fee, rounded up to the nearest whole cent. The daily accruals are presented on the Web page for informational purposes only.
To avoid defrauding of the billing process, the Subscriber billing process may, in some embodiments, account for intra-day additions, updates and deletions to Electronic Records. For example, a record created at 9:00AM, updated at 10:00AM and deleted at 11:00AM may still be charged for a complete day. Also, a record created at 9:00AM with no optional data, updated at 10:00AM with 120 characters of optional data, and later updated with fewer than 120 characters or deleted may still be charged for a complete day with 120 characters.

This can be further exaggerated through the user of the Subscriber API.

Subscriber billing may also include a charge associated with using the API and allow for discounts and other pricing breakpoints based upon number of Electronic records.

Subscriber accounts and the associated Electronic Records that have billing(s) past due for over 6 months may be marked in-active, with a confirmation email and a physical postal letter (or other secondary means of contact) sent to the Subscriber. In-active records may not be included in the result set of a User query. The account and the associated Electronic Records may be re-activated upon receipt of payment in full for all currently outstanding charges. Subscriber accounts that have been marked in-active for over 6 months may be removed from the system, with a confirmation email, and physical postal letter (ot other secondary contact means) sent to the user. Upon removal from the system, the account will be transferred to the billing department for final processing of any outstanding balance.

Advertiser Billing

Advertiser billing may be performed monthly, based on the previous calendar month activity. Advertiser charges are broken down by count, and type (impressions, click-thrus, and conversions), aggregated by delivery channel across all records they own (allowing for different rates per channel). Advertiser charges may be accrued daily based on the number, type and Interface. Daily accruals are totaled at the end of the calendar month and applied to the Advertiser account. Fractional charges may be carried over to the next billing cycle. For example, 200 impressions billed at x-cents per thousand would be carried over; 1200 impressions billed at x-cents per thousand would have 1000 billed and 200 carried over.

Advertiser accounts and their associated content that have payment past due for over 6 months may be marked in-active, with a confirmation email and physical postal letter sent to the Advertiser. In-active Advertiser records will not be included in any delivery channel. The account and the associated Advertiser Records may be re-activated upon receipt of payment in full for all currently outstanding charges. Advertiser accounts that have been marked In-active for over 6 months (configurable) will be removed from the system, with a confirmation email and physical postal letter sent to the user. Upon removal from the system, the account will be transferred to the billing department for final processing of any outstanding balance.

Subscriber Data

Subscriber Data billing will be performed monthly, in advance for the following month. For partial months the fixed fee is computed pro-rata based on calendar days.

General Data

General Data billing will be performed monthly, in advance for the following month. For partial months the fixed fee is computed pro-rata based on calendar days. Data may not be delivered if payment is not received in advance. FTP access will be disabled (marked “In-active”) for user accounts who have not paid in 6 months. FTP access that has been marked “In-active” for over 6 months will be removed the system, with the data also deleted.

Tools

Pursuant to some embodiments, a number of “tools” may be provided to facilitate interaction, management and use of the system of the present invention. The following set of tools is not exhaustive and is provided for illustration only.

Support Tools

Support Tools are a collection of utilities used by the employee (Support, Security, Billing, Technical, Management, etc) of the Email Exchange to perform a repetitive task required to analyze, maintain and support the service. These tools will be easy to use, have a common interface and be usable onsite and remotely. These include, but will not be limited to:
manually creating, updating or deleting any type of data record on behalf of an end-user, preserving any data relationships and system integrity;
changing the status (e.g. Pending, Active, In-Active) of any data element or record;
enabling or disabling access of any account (Enhanced User, Subscriber, Advertiser, API, etc.);
system integrity check scripts—Electronic records (other than those that are un-verified) that are not linked back to a Subscriber;
record/maintain customer (subscriber, advertiser, other) billing information, including the ability to post payments, credits, adjustments or any other transaction to their account;
an automated process will produce and make available Subscriber Data; and
an automated process will produce and make available General Data.

Data Content Tools

In addition to the Support Tools, a collection of embedded and standalone tools used by The Email Exchange to validate/verify data content for all record types at the point of entry or update, and facilitate regular scans and audits of the system. Accuracy is a vital part of the service. At a minimum, these tools will perform the following checks:
language—detecting profanity or other inappropriate content;
consistent/valid City, State and Zip combination;
consistent/valid City, Country and Postal Code combination;
valid email, text and IM address;
valid URL;
strong Password check; and
etc.

Any suspicious data may be included in a regular internal customer service report of the Email exchange. Individual items will be optionally sent via email to the address on file associated with the record to verify or confirm whether the data is accurate and legitimate. Additional or other data verification checks may be performed by comparing select or combinations of data against other web sites or electronically available feeds.

Security Processes and Tools

In addition to the Support Tools, a collection of embedded processes and standalone tools used by the Email Exchange to maintain and enforce system security and integrity for all functionality, services and data. System logs herein may be a key part of monitoring, detection and reporting on system security. The results will generate real-time alerts and summary information to be reported on demand as well as regular intervals to The Email Exchange security and support professionals. These include:
enforcing strong passwords for all accounts. A Strong Password is defined as:
   at least 6 characters long;
   at least one letter, one number and one special character; and
   a combination of upper and lower case letters;
weak passwords will not be accepted or allowed at point of entry or update;
detecting repetitive failed login attempts, online or via the API. In addition to generating an alert, this will result in the account being marked in-active, and an email sent to the address on record with a URL to click on to re-activate the account;
detecting a large number of requests performed over a very short amount of time, force a delay between subsequent requests and eventually prevent them over time, this will generate an alert. This type of alert may suggest an automated system or application that is attempting to extract records for purposes other than the Email Exchange. This action can be or lead to a security event to be addressed by Email Exchange security support professionals;
detecting and reporting irregular site activity or attempts to hack into The Email Exchange;
detecting and reporting irregular API usage; and
detecting and reporting irregular Applet/Add-in usage;

Other requirements of the service may include:
Capacity Planning—insuring that the staff and infrastructure of The Email Exchange can support normal and peak usage, current and anticipate growth, etc.; and
BCP Planning—insuring that the necessary backup, redundancy and failover mechanisms and processes are in place and tested periodically to insure high availability of the service.

Web Crawlers

Pursuant to some embodiments, the system of the present invention will utilize one or more Web Crawlers to collect and create un-verified electronic records. An un-verified electronic record is defined as one that was not created by a Subscriber, but instead is a result of an automated process of navigating the Internet and collecting email addresses and other related contact information that is part of an electronic record. These records may be inserted into the database, marked with a special Status and an email sent, inviting the individual/business to become a Subscriber of the service. A User of the service will have the ability to filter out these records when viewing the results of their query.

The Web Crawler may support broad based and targeted email address collection. Targeted collection will be based on a user supplied keyword, category or other field(s) of an electronic record field that is found on the web page or site being scanned. Using a configurable and proprietary algorithmic matching process, qualified records will be added to the database. The Web Crawler process may be used to help during the startup/launch phase of The Email Exchange, and periodically for marketing purposes to attract new Subscribers. Un-verified electronic records may be live in the system for 6 months, after which time they will be marked defunct, sent a second email notification/invitation, and removed from future Web Crawler activity.

Directory Services

In some embodiments the system of the present invention may deploy the services described herein in a “walled-off” environment with sufficient password protection and security. This “cloned” environment will allow clients the ability to out-source the support and maintenance of their internal (non-public) email directory and take advantage of the many unique features and benefits of the Email Exchange.

For this environment, the API will allow full lookup functionality. For compatibility, the API will be enhanced (if necessary) to integrate with a number of popular email clients and directory services protocols (e.g. Outlook, Thunderbird, iMail, Eudora, LDAP, etc).

Embodiments of the present invention have been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method for providing an exchange database system, the method comprising:
automatically collecting contact information associated with a business or service provider;
storing the automatically collected contact information in a plurality of data records, each data record being associated with a business or service provider;
inviting the business or service provider associated with each of the plurality of data records to verify the automatically collected contact information and to subscribe to a service to maintain their associated contact information; and
providing access the automatically collected contact information to subscribers and non-subscribers.

2. The method of claim 1, further comprising providing an indication that the automatically collected contact information is not verified, unless the invited business or service provider verifies their associated contact information in the plurality of data records.

3. The method of claim 2, wherein access to the automatically collected contact information that is not verified is denied after a predetermined time period in the instance the invited business or service provider fails to verify their associated contact information within the predetermined time period.

4. The method of claim 1, wherein a subscriber is provided with a capability to create, verify, modify, their associated contact information and other optional data content.

5. The method of claim 1, further comprising generating a personal mailing list for the business or service provider, the mailing list including customized contact listings for the business or service provider.

6. The method of claim 5, further comprising automatically providing an electronic notification to the business or service provider in the instance contact information associated with the personal mailing list for the business or service provider changes.

7. The method of claim 1, further comprising:
executing a query against the plurality of data records;
storing a record of inputs and results associated with the query; and
providing the results of the query to a user.

8. The method of claim 1, further comprising:
providing access to the plurality of data records to an advertiser; and
collecting fees from the advertiser, based at least in part, on the access provided.

9. The method of claim 1, providing a programmable interface to the invited business or service providers to provide access to their associated contact information, wherein the programmable interface provides functionality to create, modify, and delete contact information and other optional data types.

10. The method of claim 1, wherein responsibility to update the contact information resides with invited business or service provider associated with the contact information.
